(19) United States
(12) Patent Application Publication
(10) Pub. No.: US 2017/0271690 A1
(43) Pub. Date: Sep. 21, 2017

(54) ELECTROCHEMICAL REACTOR BALANCING THE PRESSURE DROPS OF THE CATHODE/ANODE HOMOGENIZATION AREAS

(71) Applicant: COMMISSARIAT A L 'ENERGIE ATOMIQUE ET AUX ENERGIES ALTERNATIVES, Paris (FR)

(72) Inventors: Remi VINCENT, Grenoble (FR); Jean-Philippe POIROT-CROUVEZIER, Saint Georges de Commiers (FR)

(73) Assignee: COMMISSARIAT A L 'ENERGIE ATOMIQUE ET AUX ENERGIES ALTERNATIVES, Paris (FR)

(21) Appl. No.: 15/329,889

(22) PCT Filed: Jul. 8, 2015
(86) PCT No.: PCT/FR2015/051893

§ 371 Date: Jan. 27, 2017

(30) Foreign Application Priority Data
Jul. 29, 2014 (FR) FR1457327

(51) Int. Cl. H01M 8/0258; H01M 8/0267; C25B 9/10

(52) U.S. Cl. CPC H01M 8/0258; C25B 9/10; H01M 8/0267

(57) ABSTRACT

An electrochemical reactor including: a diaphragm/electrodes assembly; at least one first reinforcement attached to one of the surfaces of the diaphragm and surrounding either the anode or the cathode; a conductive bipolar plate including a first flow manifold passing therethrough, one first surface including flow channels from a cathode reactive area and moreover including cathode homogenization channels placing the cathode reactive area in communication with the first collector; and at least one element from among the diaphragm and the first reinforcement not covering the cathode homogenization channels, depth of the cathode homogenization channels being greater than depth of the flow channels of the cathode reactive area.

The invention relates to electrochemical reactors that include a stack of individual electrochemical cells, and more particularly a stack that includes bipolar plates and proton exchange membranes. Such electrochemical reactors constitute, for example, fuel cells or electrolysers.

Fuel cells are in particular envisaged as a source of energy for mass-produced automotive vehicles in the future or as sources of auxiliary energy in aeronautics. A fuel cell is an electrochemical device that converts chemical energy directly into electrical energy. A fuel cell comprises a stack, in series, of several individual cells. Each individual cell typically generates a voltage of the order of 1 volt, and the stack thereof makes it possible to generate a higher level supply voltage, for example of the order of about a hundred volts.

Among the known types of fuel cells, mention may in particular be made of the proton exchange membrane (PEM) fuel cell that operates at low temperature. Such fuel cells have particularly advantageous compactness properties. Each individual cell comprises an electrolytic membrane that allows only protons to pass through and not electrons. The membrane comprises an anode on a first face and a cathode on a second face in order to form a membrane electrode assembly (MEA).

At the anode, molecular hydrogen used as fuel is ionized in order to produce protons that pass through the membrane. The membrane thus forms an ion conductor. Electrons produced by this reaction migrate toward a flow plate, then pass through an electrical circuit external to the individual cell in order to form an electric current. At the cathode, oxygen is reduced and reacts with the protons to form water.

The fuel cell may comprise several plates, referred to as bipolar plates, for example made of metal, stacked on top of one another. The membrane is positioned between two bipolar plates. The bipolar plates may comprise flow channels and orifices in order to continuously guide the reactants and the products to/from the membrane. The bipolar plates also comprise flow channels in order to guide coolant that discharges the heat produced. The reaction products and the non-reactive species are discharged by entrainment by the flow to the outlet of the networks of flow channels. The flow channels of the various flows are separated by means of bipolar plates in particular.

The bipolar plates are also electrically conductive in order to collect electrons generated at the anode. The bipolar plates also have a mechanical role of transmitting the stack clamping forces, necessary for the quality of the electrical contact. Gas diffusion layers are inserted between the electrodes and the bipolar plates and are in contact with the bipolar plates.

Electron conduction is carried out through the bipolar plates, ion conduction being obtained through the membrane.

Three methods of circulation of the reactants in the flow channels are mainly distinguished:
serpentine channels: one or more channels run across the entire active surface in several to-and-from paths;
parallel channels: a bundle of parallel and through channels runs across the active surface from side to side. The flow channels may be straight or slightly wavy;
interdigital channels: a bundle of parallel and blocked channels runs across the active surface from side to side. Each channel is blocked either from the fluid inlet side, or from the fluid outlet side. The fluid entering a channel is then forced to pass locally through the gas diffusion layer in order to join an adjacent channel and then reach the fluid outlet of this adjacent channel.

In order to favor the compactness and the performance, the design involves reducing the dimensions of the flow channels. The method of circulation by parallel channels is then favored, in order to limit the pressure drops in such flow channels of reduced dimensions, and to avoid coolant flow problems that may lead to hot spots.

With parallel flow channels, the distribution of the reactants at the electrodes should be as homogeneous as possible over the entire surface, to avoid impairing the operation of the electrochemical reactor. For this purpose, the bipolar plates comprising parallel flow channels frequently use homogenizing zones in order to couple inlet and outlet manifolds to the various flow channels of the bipolar plates. The reactants are brought into contact with the electrodes using inlet manifolds and the products are discharged using outlet manifolds connected to the various flow channels. The inlet manifolds and the outlet manifolds generally pass right through the thickness of the stack. The inlet and outlet manifolds are usually obtained by:
respective orifices passing through each bipolar plate at its periphery;
respective orifices passing through each membrane at its periphery;
by gaskets, each inserted between a bipolar plate and a membrane. Each gasket surrounds an orifice of its membrane and an orifice of its bipolar plate. The contact surface with a membrane is generally flat in order to very much keep this membrane flexible.

Various technical solutions are known for placing the inlet and outlet manifolds in communication with the various flow channels. It is in particular known to produce passages between two metal sheets of a bipolar plate. These passages open on the one hand into orifices of respective manifolds, and on the other hand into injection orifices. A homogenizing zone comprises channels that place injection orifices in communication with flow channels.

The homogenizing zone comprises: a coolant transfer zone, an oxidant circuit homogenizing zone and a fuel circuit homogenizing zone that are superposed and that open respectively toward a coolant manifold, an oxidant circuit manifold and a fuel circuit manifold.

In practice, with molecular hydrogen as fuel circulating at the anode and molecular oxygen as oxidant in air circulating at the cathode, a very great pressure drop disparity appears between the two flows for the same flow circuits in the homogenizing zones and in the flow channels of the reactive zone. The ratio of pressure drops between the flow of molecular hydrogen and of air is then generally between 2 to 10. On the one hand, molecular hydrogen is generally less viscous than air including molecular oxygen, and on the other hand its flow rate is lower. The pressure drops in the air flow may thus be very detrimental for the reactor performance.

Furthermore, in the presence of homogenizing zones, it is observed that they generate a sizeable portion of the pressure drops in the flows, in particular in designs that aim to reduce the bulkiness of these homogenizing zones which do not participate or participate only partially in the electrochemical reaction.

The invention aims to solve one or more of these drawbacks. The invention thus relates to an electrochemical reactor as defined in the appended claims.

Document US 2010/0129694 and document US 2010/0129265 describe a fuel cell equipped with a membrane electrode assembly between bipolar plates. These documents propose to reduce the pressure drops in a fluid inlet zone relative to a fluid outlet zone. A first embodiment relates to a homogenizing zone without homogenizing channels. A second embodiment relates to a homogenizing zone with flow channels. In the second embodiment, the pressure drop reduction is achieved by increasing the width of the inlet flow channels relative to the outlet flow channels. The membrane electrode assembly described lacks reinforcement in all the embodiments. The membrane covers the flow channels and the homogenizing zones of the anode and cathode plates in all the embodiments.

Other features and advantages of the invention will become clearly apparent from the description that is given thereof below, by way of nonlimiting illustration, and with reference to the appended figures, in which:

FIG. 1 is an exploded perspective view of an example of a stack of membrane electrode assemblies and of bipolar plates for a fuel cell;

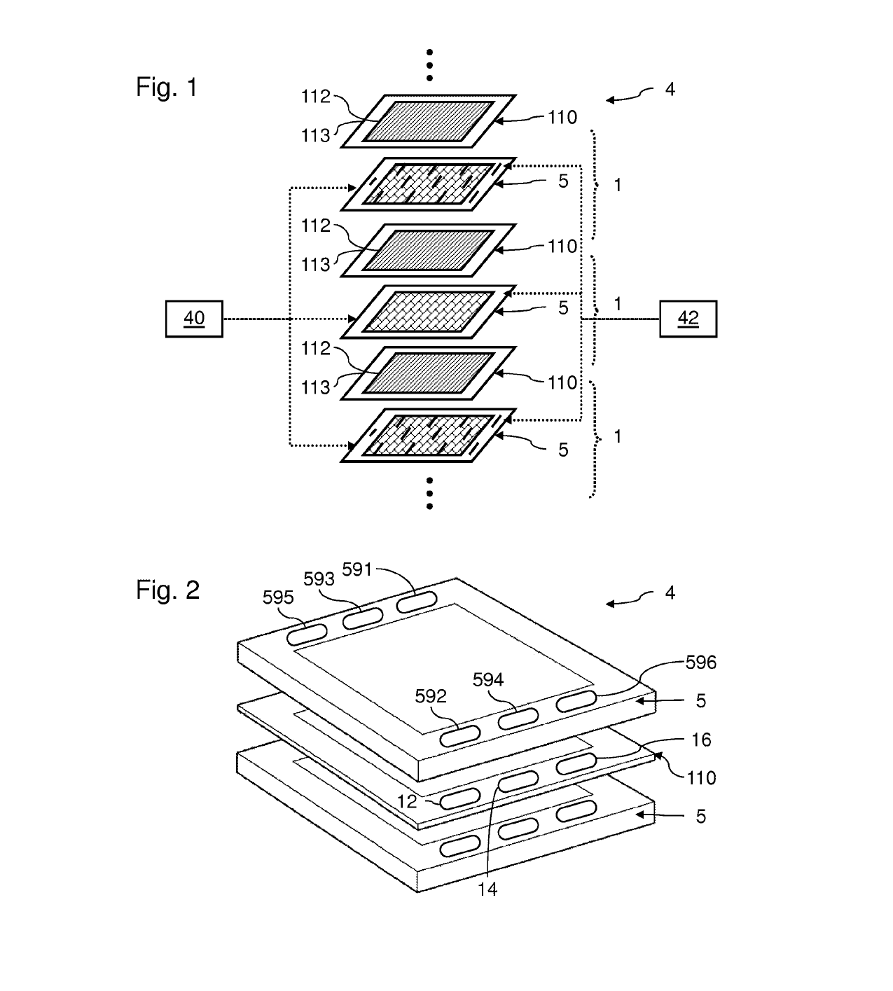

FIG. 2 is an exploded perspective view of bipolar plates and of a membrane electrode assembly that are intended to be stacked in order to form flow manifolds through the stack;

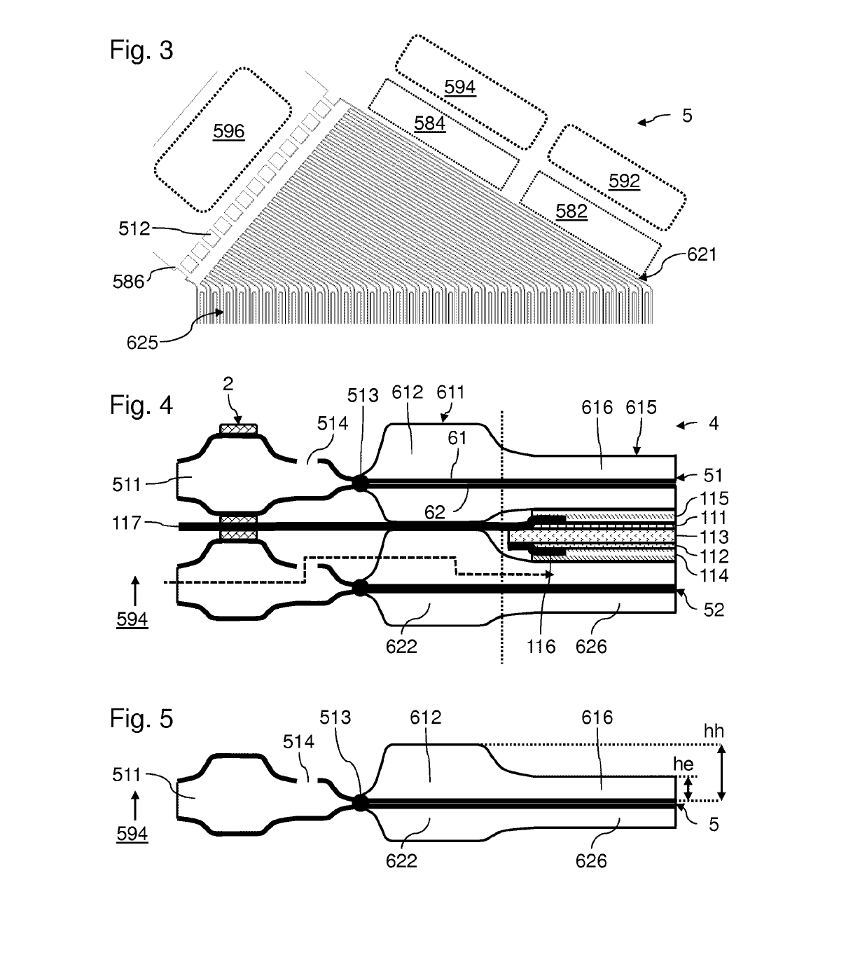

FIG. 3 is a partial bottom view of a metal sheet of an example of a bipolar plate

FIG. 4 is a schematic cross-sectional view along a flow path for a stack that includes bipolar plates according to one exemplary embodiment of the invention;

FIG. 5 is a cross-sectional view of a bipolar plate of the stack from FIG. 4;

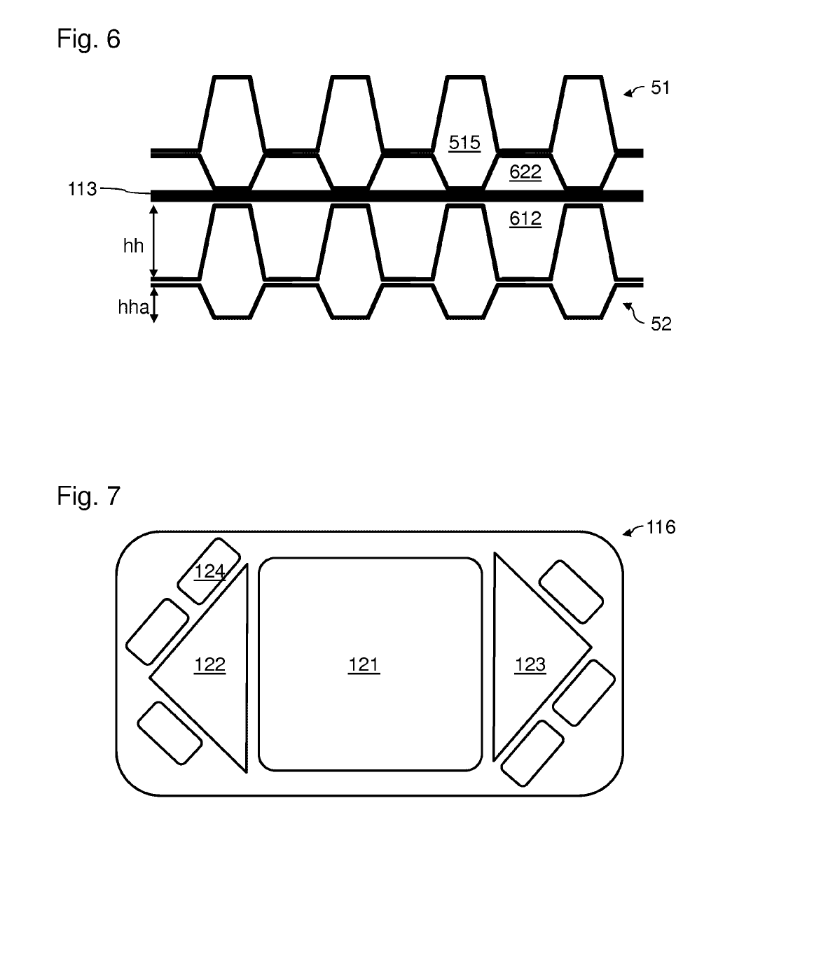

FIG. 6 is a transverse cross-sectional view of a stack according to FIG. 4 at homogenizing zones;

FIG. 7 is a top view of an example of reinforcement that does not cover a homogenizing zone.

FIG. 1 is a schematic exploded perspective view of a stack of individual cells 1 of a fuel cell 4. The fuel cell 4 comprises several superposed individual cells 1. The individual cells 1 are of proton exchange membrane or polymer electrolyte membrane type.

The fuel cell 4 comprises a source of fuel 40. The source of fuel 40 here supplies an inlet of each individual cell 1 with molecular hydrogen. The fuel cell 4 also comprises a source of oxidant 42. The source of oxidant 42 here supplies an inlet of each individual cell 1 with air, oxygen from the air being used as oxidant. Each individual cell 1 also comprises exhaust channels. One or more individual cells 1 also have a cooling circuit.

Each individual cell 1 comprises a membrane electrode assembly 110 or MEA 110. A membrane electrode assembly 110 comprises an electrolyte 113, a cathode 112 and an anode (not illustrated) which are placed on either side of the electrolyte and fastened to this electrolyte 113. The layer of electrolyte 113 forms a semi-permeable membrane that allows protons to be conducted while being impermeable to the gases present in the individual cell. The layer of electrolyte also prevents passage of electrons between the anode and the cathode 112.

Between each pair of adjacent MEAs, a bipolar plate 5 is positioned. Each bipolar plate 5 defines anodic flow channels and cathodic flow channels. Bipolar plates 5 also define coolant flow channels between two successive membrane electrode assemblies.

In a manner known per se, during the operation of the fuel cell 4, air flows between an MEA and a bipolar plate 5, and molecular hydrogen flows between this MEA and another bipolar plate 5. At the anode, the molecular hydrogen is ionized in order to produce protons that pass through the MEA. The electrons produced by this reaction are collected by a bipolar plate 5. The electrons produced are then applied to an electrical load connected to the fuel cell 1 in order to form an electric current. At the cathode, oxygen is reduced and reacts with the protons to form water. The reactions at the anode and the cathode are governed as follows:

H₂→2H⁺+2e⁻ at the anode;

4H⁺+4e⁻+O₂→2H₂O at the cathode.

During its operation, one individual cell of the fuel cell usually generates a DC voltage between the anode and the cathode of the order of 1 V.

FIG. 2 is a schematic exploded perspective view of two bipolar plates 5 and of a membrane electrode assembly that are intended to be included in the stack of the fuel cell 4. The stack of the bipolar plates 5 and of the membrane electrode assemblies 110 is intended to form a plurality of flow manifolds, the arrangement of which is illustrated here in a schematic manner only. For this purpose, respective orifices are made through the bipolar plates 5 and through the membrane electrode assemblies 110. The bipolar plates 5 thus comprise orifices 591, 593 and 595 at a first end, and orifices 592, 594 and 596 at a second end opposite the first. The orifice 591 is used for example to form a fuel supply manifold, the orifice 596 is used for example to form a combustion residue discharge manifold, the orifice 595 is used for example to form a coolant supply manifold, the orifice 592 is used for example to form a coolant discharge manifold, the orifice 594 is used for example to form an oxidant supply manifold, and the orifice 593 is used for example to form a water discharge manifold.

The orifices of the bipolar plates 5 and of the membrane electrode assemblies 110 are positioned opposite in order to form the various flow manifolds. Orifices 12, 14 and 16 are for example made in the membrane electrode assemblies 110 and are positioned opposite respectively the orifices 592, 594 and 596. For the sake of simplification, the orifice 594 will be likened to an oxidant supply manifold.

FIG. 3 is a partial schematic bottom view of a metal sheet 61 of an exemplary embodiment of a bipolar plate 5 according to the invention, at the manifolds 592, 594 and 596. FIG. 4 is a cross-sectional view of a stack including bipolar plates 51 and 52 identical to the plate 5. A membrane 113 of a membrane electrode assembly is positioned between the bipolar plates 51 and 52. The cross-sectional view here follows the oxidant flow path between cathodic flow channels and the manifold 594. An example of a bipolar plate 5 is shown in further detail in the cross-sectional view of FIG. 5.

Each of the bipolar plates 5, 51 and 52 illustrated includes two attached conductive metal sheets 61 and 62. The conductive metal sheets 61 and 62 are advantageously (but nonlimitingly) made of stainless steel, a very common material suitable for many widespread industrial transformation processes, for example drawing, stamping and/or punching. The conductive metal sheets 61 and 62 are here attached by means of welds 513.

In a manner known per se, the various manifolds passing through the stack communicate with respective injection zones. In the example illustrated in FIG. 3, the manifold 596 communicates with an injection zone 586, the manifold 594 communicates with an injection zone 584 and the manifold 592 communicates with an injection zone 582. Each injection zone comprises respective injection orifices in communication with respective flow channels. The injection zones 586, 584 and 582 are offset laterally so as to be able to house several manifolds at a same end of a bipolar plate.

Injection orifices 512 are made in the metal sheet 62 in the injection zone 586. Injection orifices 514 are made in the metal sheet 61 in the injection zone 584. As illustrated in FIG. 4, the orifices 514 communicate with the manifold 594 in particular by means of a passage 511 passing through support ribs of gaskets 2. The support ribs and the gaskets 2 surround the manifold 594.

Fluid communications, which are not described and not illustrated, are also made on the one hand between the manifold 596 and the injection zone 586, and on the other hand between the manifold 592 and injection zone 582.

The conductive metal sheets 61 and 62 are in relief, so as to make fluid flow channels at the outer faces of each bipolar plate, and advantageously between the conductive metal sheets 61 and 62 within each of these bipolar plates. The conductive metal sheet 61 comprises a reactive zone 615 and a homogenizing zone 611 on its outer face. The reactive zone 615 comprises flow channels 616. The homogenizing zone 611 comprises homogenizing channels 612 placing the injection zone 584 in communication with the reactive zone 615, as illustrated by the dotted-line arrow.

The conductive metal sheet 62 comprises a reactive zone 625 and a homogenizing zone 621 on its outer face. The reactive zone 625 comprises flow channels 626. The homogenizing zone 621 comprises homogenizing channels 622 placing the injection zone 586 in communication with the flow channels 626.

A homogenizing zone is generally differentiated from a reactive zone by the absence of electrode overhanging this homogenizing zone in the membrane electrode assembly 110, and/or by the presence of homogenizing channels having a lateral deviation relative to the flow channels of the reactive zone, so as to make the homogenizing zone more compact. The role of a homogenizing zone is in particular to limit the difference in flow rates between the various flow channels of its respective reactive zone and to homogenise the pressure drops for the various possible flow paths.

The membrane electrode assembly 110 here comprises a reinforcement 116 surrounding the cathode 112 and fastened to the membrane 113. The reinforcement 116 comprises a median opening giving access to the cathode 112. A gas diffusion layer 114 is positioned here in contact with the cathode 112 across this median opening. In this example, the membrane electrode assembly 110 also comprises a reinforcement 117 surrounding the anode 111 and fastened to the membrane 113. The reinforcement 117 comprises a median opening giving access to the anode 111. A gas diffusion layer 115 is positioned here in contact with the anode 111 across this median opening.

The dotted line illustrates the boundary between the reactive zones 615, 625 and the homogenizing zones 611, 621. According to the invention, at least one reinforcement or the membrane 113 does not extend as far as the homogenizing zones 611, 621 and does not therefore cover the homogenizing channels 612, 622.

Thus, the thickness of the membrane electrode assembly 110 covering the homogenizing zones 611 and 621 is less than the thickness of this membrane electrode assembly 110 at a superposition between the membrane 113 and the reinforcements 116 and 117.

In the example illustrated, two elements from among the membrane 110 and the reinforcements 116 and 117 do not extend as far as the homogenizing zones 611, 621. In particular, the membrane 113 and the reinforcement 116 do not extend as far as the homogenizing zones 611, 621.

Thus, the thickness of the membrane electrode assembly 110 covering the homogenizing zones 611 and 621 is reduced even more relative to the superposition between the membrane 113 and reinforcements 116 and 117.

Consequently, the depth of the homogenizing channels 612 may be increased, so as to reduce the pressure drops of the flow passing through the homogenizing zone 611. As illustrated in FIG. 5, the depth of the homogenizing channels 612 (illustrated by the parameter hh) is greater than the depth of the flow channels 616 (illustrated by the parameter he). Namely Δh=hh−he.

The difference in depth between the homogenizing channels 612 and the flow channels 616 is at least equal to the thickness of the membrane 113 (thickness em) or of the reinforcement 116 (thickness er116) not extending as far as the homogenizing zone 611: Δh≧em or Δh≧er116.

The depth em is typically between 15 and 60 μm.

If at least two elements from among the membrane 113 and the reinforcements 116 and 117 (thickness er117) do not extend as far as the homogenizing zone 611, the difference in depth between the homogenizing channels 612 and the flow channels 616 is at least equal to the sum of the thickness of these two elements: Δh≧em+er116 or Δh≧em+er117 or Δh≧er116+er117.

Furthermore, in the presence of a gas diffusion layer 114 in contact with the cathode 112, the differences in depth mentioned above are further increased by the thickness of the gas diffusion layer 114.

FIG. 6 is a transverse cross-sectional view of a stack at the homogenizing zones 611 and 621. The depth hh of the homogenizing channels 612 is advantageously greater than the depth hha of the homogenizing channels 622, in order to balance the pressure drops of the cathodic flow and of the anodic flow.

Namely Δhca=hh−hha.

Depending on the elements that do not cover the homogenizing zone 611, provision may be made for Δhca≧em or Δhca≧er116 or Δhca≧er117 or Δhca≧em+er116 or Δhca≧em+er117 or Δhca≧er116+er117.

The depth hha of the homogenizing channels 622 is typically between 200 and 500 μm. The width of the homogenizing channels 622 and 612 (defined by their average width) is typically between 1 and 3 mm. The thickness em is typically between 15 and 60 μm. The thicknesses er116 and er117 are typically between 30 and 200 μm.

It is possible to envisage, depending on the scenario, a depth difference Δhca between 15 and 400 μm.

For example, with em=25 μm, er116=50 μm and er117=50 μm, according to the example illustrated in FIG. 4, simulations have enabled a pressure drop reduction on the cathode side of 30% to be observed.

In FIG. 6, coolant flow channels 515, made within the bipolar plates 51 and 52 are also distinguished.

FIG. 7 is a top view of an example of reinforcement 116 for a stack according to FIG. 4. The reinforcement 116 comprises a median through opening 121, intended to give access to the cathode 112. The reinforcement 116 also comprises through orifices 122 and 123. The orifices 122 and 123 are positioned on either side of the median opening 121. The orifices 122 and 123 are intended to be passed through by the walls of the flow channels 612 of homogenizing zones 611, made on either side of a reactive zone 615. The reinforcement 116 also comprises orifices 124, positioned on either side of the median opening 121, in order to form passages for the manifolds of the stack.

The membrane electrode assembly 110 covers the homogenizing zone 611 of the plate 52 and the homogenizing zone 622 of the plate 51 in order to separate a cathodic flow from an anodic flow. The membrane electrode assembly 110 extends here up to gaskets 2, covering injection orifices 514. In this example, only the anodic reinforcement 117 of the membrane electrode assembly 110 covers the homogenizing zones.

The flow channels 616 and the flow channels 626 are here of parallel type and extend along the same direction. These various flow channels are not necessarily rectilinear (these channels may have a wave), their direction being defined by a straight line connecting their inlet to their outlet.

The invention has been described with reference to an injection of a molecular hydrogen type fuel into a fuel cell. The invention of course also applies to the injection of other types of fuels, for example methanol.

The invention has been described with reference to an electrochemical reactor of proton exchange membrane fuel cell type. The invention may of course also apply to other types of electrochemical reactors, for example an electrolyser also comprising a stack of bipolar plates and of proton exchange membranes.

1-10. (canceled)

11. An electrochemical reactor, comprising:
a membrane electrode assembly including a proton exchange membrane, an anode on a first face of the membrane, a cathode on a second face of the membrane, at least one first reinforcement fastened to one of the faces of the membrane and surrounding either the anode, or the cathode;
a conductive bipolar plate passed through by a first flow manifold, a first face including flow channels of a cathodic reactive zone and including cathodic homogenizing channels placing the cathodic reactive zone in communication with the first manifold;
at least one element from the membrane and the first reinforcement not covering the cathodic homogenizing channels, and depth of the cathodic homogenizing channels being greater than depth of the flow channels of the cathodic reactive zone.

12. The electrochemical reactor as claimed in claim 11, wherein the first reinforcement surrounds the cathode, the reactor further comprising a second reinforcement fastened to the first face of the membrane and surrounding the anode, at least two elements from the membrane and the first and second reinforcements not covering the cathodic homogenizing channels.

13. The electrochemical reactor as claimed in claim 11, wherein the flow channels of the cathodic reactive zone extend in a same direction.

14. The electrochemical reactor as claimed in claim 11, further comprising a gas diffusion layer in contact with the cathode.

15. The electrochemical reactor as claimed in claim 14, wherein difference in depth between the cathodic homogenizing channels and the flow channels of the cathodic reactive zone is at least equal to the sum of thickness of the gas diffusion layer and of thickness of the element not covering the cathodic homogenizing channels.

16. The electrochemical reactor as claimed in claim 12, wherein difference in depth between the cathodic homogenizing channels and the flow channels of the cathodic reactive zone is at least equal to the sum of thickness of the gas diffusion layer and of thicknesses of the two elements not covering the cathodic homogenizing channels.

17. The electrochemical reactor as claimed in claim 11, wherein the bipolar plate is passed through by a second flow manifold, a second face of the bipolar plate comprising flow channels of an anodic reactive zone and comprising anodic homogenizing channels placing the anodic reactive zone in communication with the second manifold, depth of the cathodic homogenizing channels being greater than the depth of the anodic homogenizing channels.

18. The electrochemical reactor as claimed in claim 17, wherein difference in depth between the cathodic homogenizing channels and the anodic homogenizing channels is at least equal to thickness of the element not covering the cathodic homogenizing channels.

19. The electrochemical reactor as claimed in claim 12, wherein difference in depth between the cathodic homogenizing channels and the anodic homogenizing channels is at least equal to the sum of thicknesses of the elements not covering the cathodic homogenizing channels.

20. The electrochemical reactor as claimed in claim 11, further comprising coolant flow channels made within the bipolar plate.
